(19) United States
(12) Patent Application Publication
(10) Pub. No.: US 2007/0192748 A1
(43) Pub. Date: Aug. 16, 2007

(54) Project management system and method

(75) Inventors: Edward Martin, Hollywood, FL (US); Maria Martin, Hollywood, FL (US)

Correspondence Address: LERNER GREENBERG STEMER LLP, P O BOX 2480, HOLLYWOOD, FL, 33022-2480, US

(73) Assignee: Marware, Inc.

(21) Appl. No.: 11/650,806

(22) Filed: Jan. 8, 2007

Related U.S. Application Data
(60) Provisional application No. 60/756,692, filed on Jan. 6, 2006.

(51) Int. Cl. G06F 3/048; G06F 17/00

(52) U.S. Cl. 715/856; 707/104.1

(57) ABSTRACT

A project management system and method are provided wherein projects can be managed easily and with minimal manual data entry. Project management software, embodying the project management system of the present invention, can run on a computer network or user workstation, without requiring a dedicated host server. The project management system of the present invention provides at least one graphical interface, to permit a user to easily create and/or edit a project, tasks, subprojects and milestones, using the mouse or other pointer device. A resource window can be provided, conveniently and consistently located in all main views of the system, to assist the user in efficiently operating the project management system. Further, projects can be automatically updated without repetitive data entry, using data entered once by the user performing a task.

### CROSS-REFERENCE TO RELATED APPLICATION

The present application claims priority from co-pending provisional patent application Ser. No. 60/756,692, filed on Jan. 6, 2006, entitled PROJECT MANAGEMENT SYSTEM AND METHOD.

### BACKGROUND OF THE INVENTION

1. Field of the Invention

The invention relates to a project management system, and more particularly to a project management system and method for managing projects utilizing an intuitive interface with minimal data entry.

2. Description of the Related Art

Project management systems are known, such as MICROSOFT PROJECT by MICROSOFT CORP. of Redmond, Wash.. However, such project management systems are currently unwieldy to use and require substantial manual data re-entry, even for data that resides in another part of the system. Further, some project management systems require their own, separate exchange server upon which they are hosted.

What is needed is a project management system that is easy to use. What is additionally needed is a project management system that does not require substantial, repetitive manual data entry. What is further needed is a project management system that does not require its own server.

### SUMMARY OF THE INVENTION

It is accordingly an object of the invention to provide a project management system and method wherein projects can be managed easily and with minimal manual data entry. Project management software, embodying the project management system of the present invention, can run on a computer network or user workstation, without requiring a dedicated host server. The project management system of the present invention provides at least one graphical interface, to permit a user to easily create and/or edit a project, tasks, subprojects and milestones, using the mouse or other pointer device. Additionally, in another preferred embodiment, a resource window can be located conveniently and consistently in all main views of the system, to assist the user in efficiently operating the project management system. Further, in another embodiment of the invention, projects can be automatically updated without repetitive data entry, using data entered once by the user performing a task.

Other features which are considered as characteristic for the invention are set forth in the appended claims.

Although the invention is illustrated and described herein as embodied in a project management system and method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a representative example of a computer network that can be used with the present invention.

FIGS. 2A and 2B are examples of graphical elements which can be used to represent the tasks of a given project in one particular embodiment of the project management system of the instant invention.

FIGS. 2C and 2D are examples of graphical elements which can be used to represent the subprojects of a given project in one particular embodiment of the project management system of the instant invention.

FIGS. 2E and 2F are examples of graphical elements which can be used to represent the milestones of a given project in one particular embodiment of the project management system of the instant invention.

FIGS. 3-5 are exemplary views of a Network view graphical interface, as used to create and/or edit projects in accordance with one particular embodiment of the project management system of the present invention.

FIG. 6 is an exemplary view of a graphical project screen of FIG. 5 shown with a task manager or resource banner, in accordance with another embodiment of the instant invention.

FIG. 7 is an exemplary view of the project of FIG. 5, represented in an Outline view in accordance with one particular embodiment of the instant invention.

FIG. 8 is an exemplary view of the project of FIG. 5, represented in a GANTT view in accordance with one particular embodiment of the instant invention.

FIGS. 9A-9B are views of individual data entry screens useful for tracking or updating projects in accordance with one particular embodiment of the present invention.

FIG. 10 is a flow diagram representative of one particular method of updating projects, in accordance with the project management system of the instant invention.

### DESCRIPTION OF THE PREFERRED EMBODIMENTS

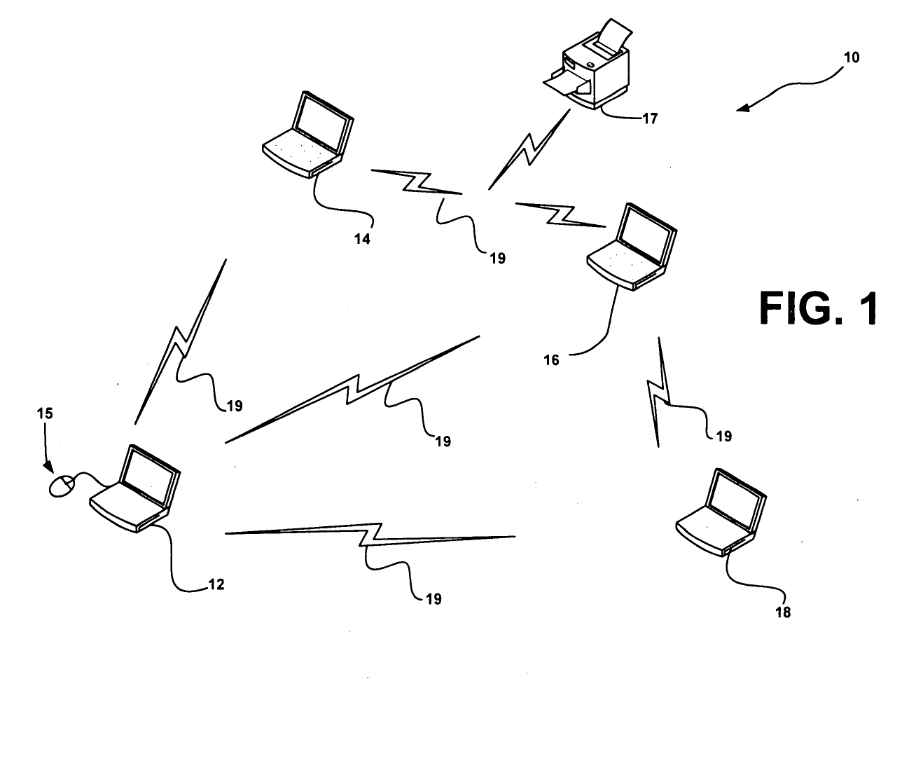

The present invention relates to a project management system embodied in software resident on a computer or computer network, such as the computer network 10 shown in FIG. 1, for facilitating the easy management of various projects. In one particular embodiment, the project management system is designed for use with MAC OS X TIGER, a product of APPLE COMPUTER, Inc. Additionally, the project management system of the instant invention need not be resident on a dedicated server. In one particular embodiment, the project management system of the instant invention resides as software on a particular user's workstation computer, such as an ordinary workstation 10 of FIG. 1, (and not a dedicated server) and is accessible over an intranet by a plurality of users (i.e., computers 14, 16, 18 of FIG. 1). An application, such as MAC WEBSERVER, produced by APPLE COMPUTER, Inc., can be used by the hosting computer (12 of FIG. 1) to host the program management system and provide access to members (for example, computers 14, 16, 18 of FIG. 1) of the Intranet. Such network can be established by known means communication paths 19, such as by wired connection, wirelessly, by telephone, by internet, etc.

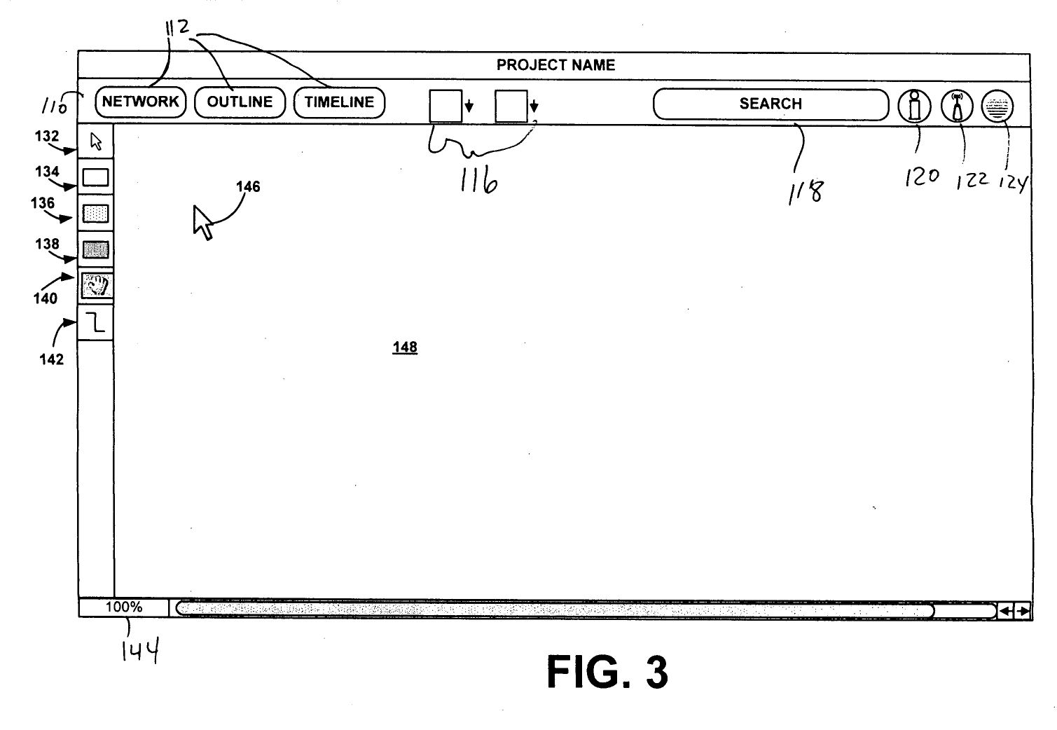

In one particular preferred embodiment of the instant invention, the project management system permits the use of three different main layouts or views (Network, Outline and Timeline) for creating and/or editing projects. Each view may be selected by actuating a project view selection soft button (for example, project view soft buttons 112 of FIG. 3) on the header or tool bar (110 of FIG. 3) of the current project management screen or by setting a default view in the system preferences.

The selected view of the project management system is displayed to a user on a display device of the workstations accessing the project management software of the instant invention. Such workstations additionally each include a mouse (15 of FIG. 1) or other pointer device, to permit the user to interact with soft buttons, project entries and blanks on the project management system screens, using an on-screen pointer or cursor arrow. Data can additionally be entered on a keyboard connected to the workstation, or imported from another data source. Reports can be displayed on a display device connected to one of the workstations and/or transmitted, via the network to another user workstation, and/or printed out on a printer (17 of FIG. 1) accessible to the network and/or a particular workstation.

Each main view for entering project data of the project management system, and its inventive features, will be discussed more fully herebelow.

The Network (PERT) View:

Whereas traditional project management software provides a PERT view option, such a PERT view has, in the past, been static, requiring the user to return to a different view to enter and/or edit data displayed in the PERT view. Contrary to traditional project management systems and software, in a preferred embodiment of the instant invention, an inventive Network or PERT view is provided which assists the user in creating and/or editing a project plan directly in the Network/PERT view of the project management system.

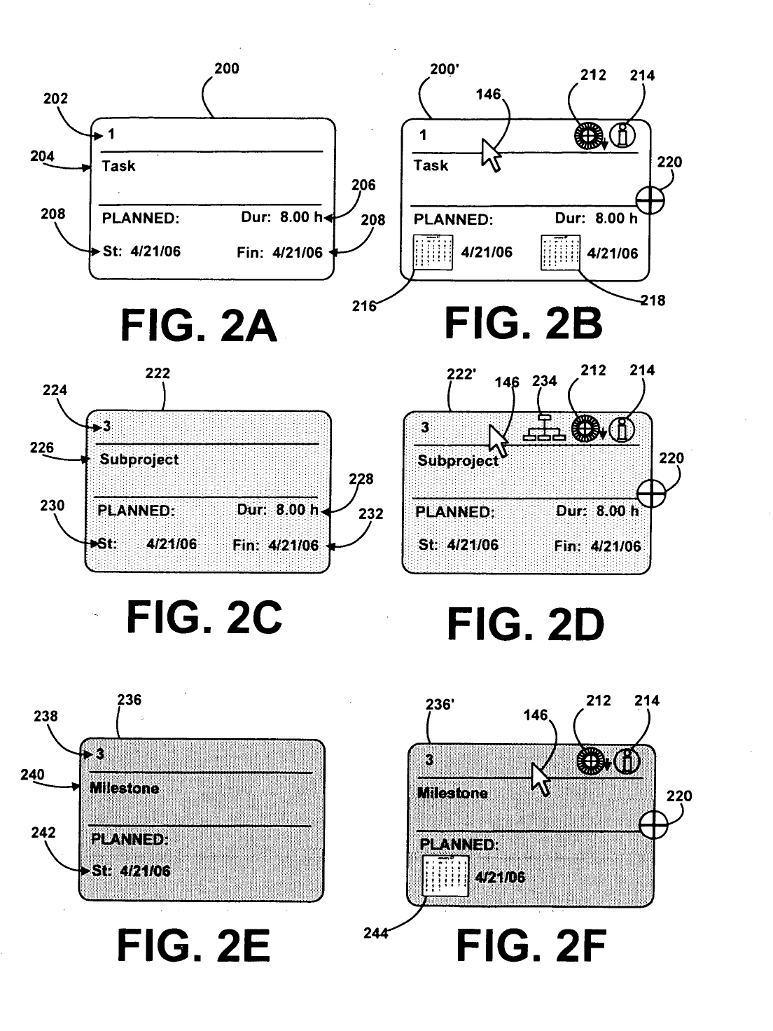

Referring now to FIGS. 2-5, there is shown a Network or PERT view, in accordance with one embodiment of the instant invention. The Network view of the instant invention is a graphical view that permits a project to be displayed as a diagram and which can be used to easily create projects in accordance with the instant invention. The Network view provides a completely graphical method of managing projects and entering data. Tasks, subprojects and milestones can be entered, merely by creating a task, subproject or milestone and associating new tasks, subtasks or milestones with it, using the “drag and drop” methodology of the user interface.

Referring more particularly to FIG. 3, there is shown a new project screen 100 in the Network view. As previously noted, each project screen, regardless of the view selected, includes a header or tool bar 110. A variety of soft buttons can be provided on the tool bar 110. For example, the particular view can be changed by the user by mousing over and selecting the desired project view soft button 112. Note that, for purposes of the instant application, the terms “mouse-over”, “moused-over”, “mousing-over”, “located over” “rolled-over”, “rolling-over” and “rollover” are used herein, interchangeably, to describe placing or passing the on-screen pointer or cursor arrow controlled by the mouse or pointing device over an entry, soft-button or other article on the display screen. In this way, a project created in one view can be displayed, at will, in any of the other available main views.

Additionally, the tool bar 110 can contain other useful buttons or information. For example, once entered, the project name can be displayed in a name bar 114, above the tool bar 110. Additionally, other soft buttons and/or drop down menus can be provided on the tool bar 110. For example, buttons 116 can provide access to further drop down menus, resources and other information, such as scheduling views (including calendar and resource views) and management views (including selectable items that track progress, review submissions and create reports). As such, menus and items are understood in the area of project management systems, they will not be further explained herein.

Additionally, the tool bar 110 of the project view screen 100 can include other soft buttons, drop down menus and interactive areas, only some of which are shown. For example, the tool bar 110 is additionally shown in FIG. 3 as including a spotlight or search window 118, into which a user can type a desired term or task name, the entry of which activates a search for that term or task name in the current project. Additionally, as will be discussed more particularly, herebelow, the tool bar 100 includes a soft button 120 that provides access, in any project view, to a task manager. Further, the tool bar 110 includes soft buttons 122 and 124 that enable collaboration with other users, as will be discussed more fully, below, by publishing the project and syncing the project, respectively. Other soft buttons, menus and fields may also be provided, but will not be shown or discussed herein. Further, in the instant embodiment, “right clicking” with the right side mouse button or “control clicking” while the pointer is over the window 148 produces additional menu options as a box in the window 148, for example, a menu including options for adjusting the view settings, grid, layout, and/or critical path of the displayed project.

The screen view shown in FIG. 3 represents a newly created project, entitled “project name”, viewed in the inventive Network view of the instant invention. In the preferred embodiment of the Network view, additional tools can be provided. For example, a toolbox 132, located at one edge of the screen, contains tools to help the user create, edit and arrange tasks. In the present preferred embodiment, the toolbox offers six tools, including a selection tool 132, a task tool 134, a subproject tool 136, a milestone tool 138, a pan tool 140 and a “critical path” tool 142. A zoom level 144 determines how much of a project is visible in the project area.

More particularly, the selection tool 132 provides the user with the on-screen pointer 146 or cursor arrow, which permits selection or moves a task or link. The task tool 134 is selected to create linked or unlinked tasks. Similarly, the subproject tool 136 and milestone tool 138 are selected to create, linked or unlinked subprojects and milestones, respectively. The pan tool 140 permits the project view to be moved within the window by “grabbing” and moving the project, using a mouse or other pointer device. The critical path tool 142, once actuated, displays the project's critical path. All of the tools can be accessed by selecting a tool from the tool box 130, using the on-screen pointer 146, or by keyboard shortcuts.

As previously stated, the Network view of FIG. 3 displays a project as a diagram, thus permitting task dependencies and critical path information to be easily seen. The task, subproject, and milestone tools 134, 136, 138, can be used to set up a project and add, delete or edit tasks, subprojects and milestones. Each graphical box can include rollover buttons, menus and/or controls, which only become visible displayed in the box when the pointer/cursor is located over a box for editing

FIGS. 2A-2E show the graphical representation of tasks, subprojects and milestones, as used in one particular embodiment of the instant invention. More particularly, FIG. 2A shows one particular embodiment of a graphical box or task element 200 used in the present invention to represent a task, graphically, in the Network project view. Such an element 200 can be created in the window (148 of FIG. 3) using the task tool (134 of FIG. 3). Once created, the task is given a number 202 and a name 204. Using the keyboard, a user can rename the task, and tab through and enter data into the duration field, 206, the start date field 208 and finish date field 210. Alternately, a series of tasks can be created and the information can be added to each task, later. Note that, in the instant invention, the task boxes can be customized to display different information, by adjusting a view settings menu of the system.

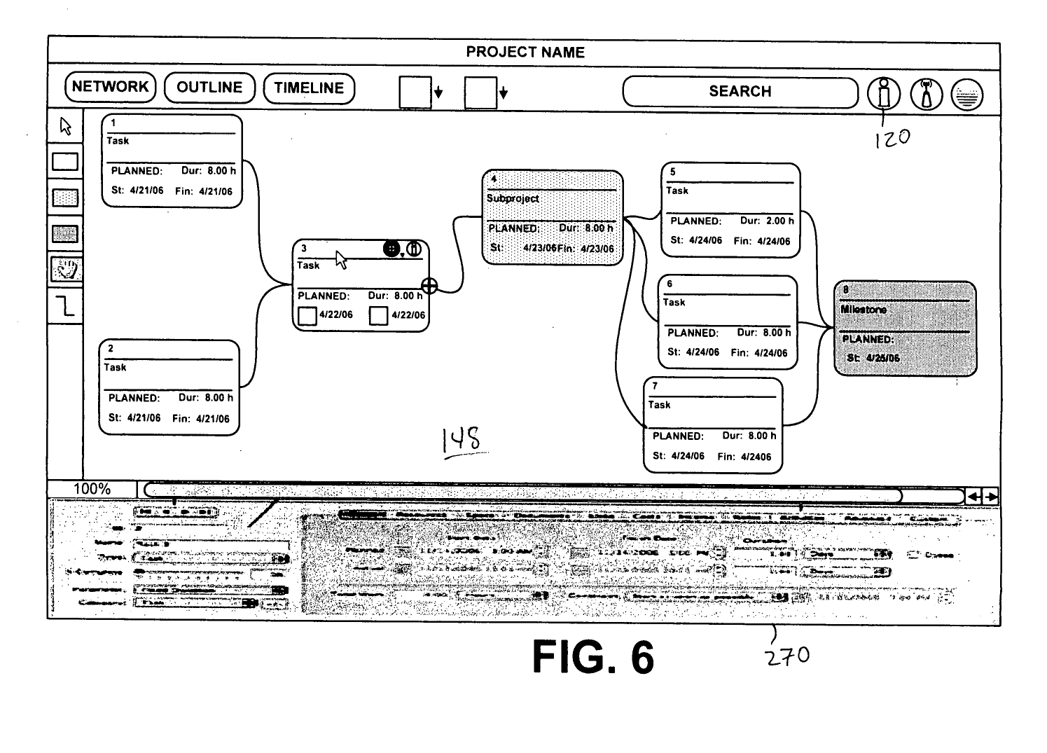

Further, the graphical task element 200, once placed in the Project view window (148 of FIGS. 3-5), is interactive when moused-over. More particularly, as shown in FIG. 2B, when moused-over with the mouse pointer 146, the element 200 transforms to the element 200′, providing access to rollover buttons, menus and elements that are only displayed on the element 200,200′ when the element 200,200′ is moused-over for editing. In the present preferred embodiment, mousing-over the element 200′ provides the user with access to an activities dropdown menu 212, a soft button 214 used for calling up a task manager, as will be discussed more fully in connection with FIG. 6, and calendar pickers 216 and 218, for helping to select the start and finish dates for the task. Further, mousing-over the element 200/200′ provides access to a connection point or “linking hotspot” 220, to assist in the linking of the element 200/200′ with other elements.

Referring now to FIGS. 2C and 2D, there is shown a graphical subproject element 222 and a dynamic version, thereof, subproject element 222′. Note that, as can be seen from the figures, the different graphical elements representing tasks, subprojects and milestones can be color-coded (as represented by the different stipling), by category, to make the diagrammed project even more easily read in the Network view. Like the task elements 200, 200′, the subproject elements 222, 222′ include an element number 224, a name 226, a duration field 228, a start date field 230 and a finish date field 232. When moused-over by the pointer 146, the subproject element 222/222′ provides further access to the dropdown activities menu 212, the task manager 214 and a connection point 220. However, as a subproject can encompass a number of tasks, a subproject expansion button 234 is additionally provided, actuation of which by the pointer 246 causes the subproject to expand into its component tasks and milestones. Note that, in the instant embodiment, calendar pickers are not provided for setting the start date and finish date fields, as these fields, as well as the duration field, are set based on the data of the underlying tasks encompassed by the subproject.

FIGS. 2E and 2F show examples of the graphical elements useful for representing milestones in the Network view of the current embodiment. More particularly, the milestone element 236 is provided including an element number 238, a milestone name 240 and a start duration field 242. Note that, in the instant embodiment, milestone elements do not include a finish date field or a duration field.

As shown more particularly in FIG. 2F, when moused-over, the milestone element 236 transforms to the element 236′, making visible and providing further access to a dropdown activities menu 212, a task manager 214 and a connection point 220. A calendar picker 244 is provided on the moused-over milestone element 236/236′, to help a user select the start date of the milestone event.

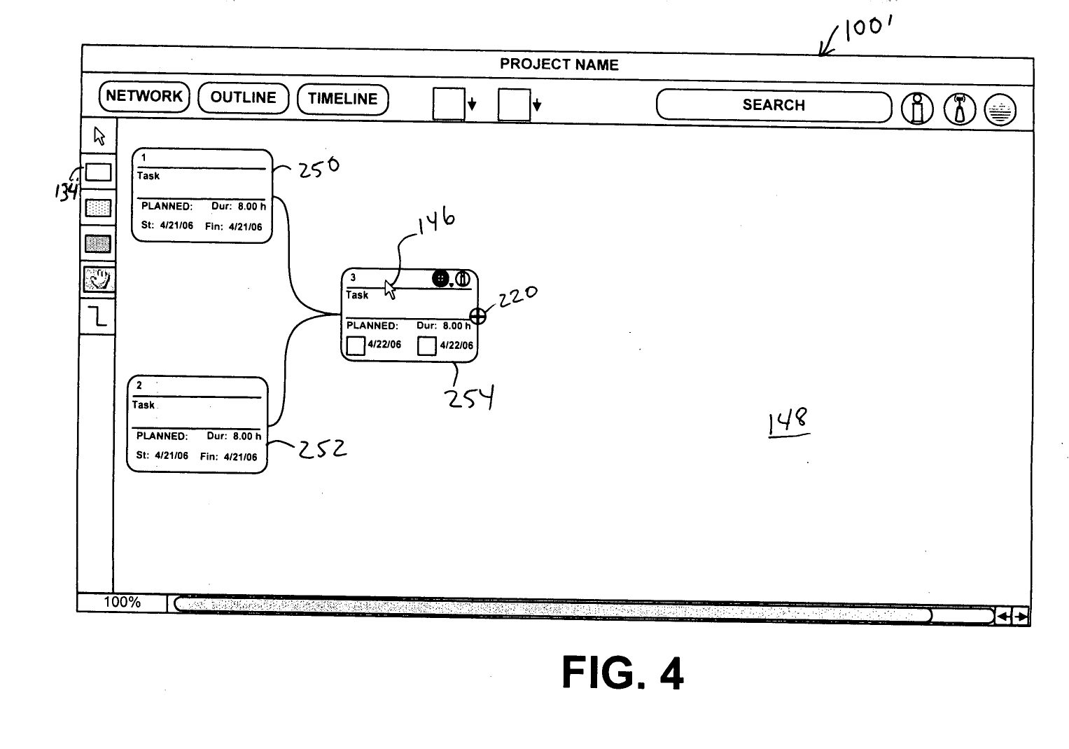

Referring back to FIG. 3, in order to place a task, milestone or subproject, a user need only click one of the task, subproject or milestone soft buttons, 134, 136, 138 on the toolbar and then click in the window 148 to deposit a graphical element of the desired type. For example, referring now to FIG. 4, there is shown a screen view of a project, shown in the Network view, having three task elements 250, 252, 254, placed therein. The first task element 250 was created by first selecting the task button 134 with the pointer, and then clicking, again with the pointer, on the desired location in the window 148′. The second task element 252 was similarly created. To create the linked task 254, one of the first task box 250 and the second task box 252 was moused-over, in order to display that element's connection point. Clicking on the displayed connection point and dragging with the mouse will create a linked task, such as the task 254. Similarly, clicking and dragging from the connection point of the other of the elements 250 and 252, to the box 254, will similarly link those two boxes. Mousing-over the task element 254 will, likewise, expose its connection point, menus and soft buttons, for editing of that task element 254. Subprojects and milestones can be added in the same way, by selecting the subproject or milestone buttons 136, 138 on the toolbar 130, and dragging and dropping from the connection point of one element to the desired location of the subproject or milestone element.

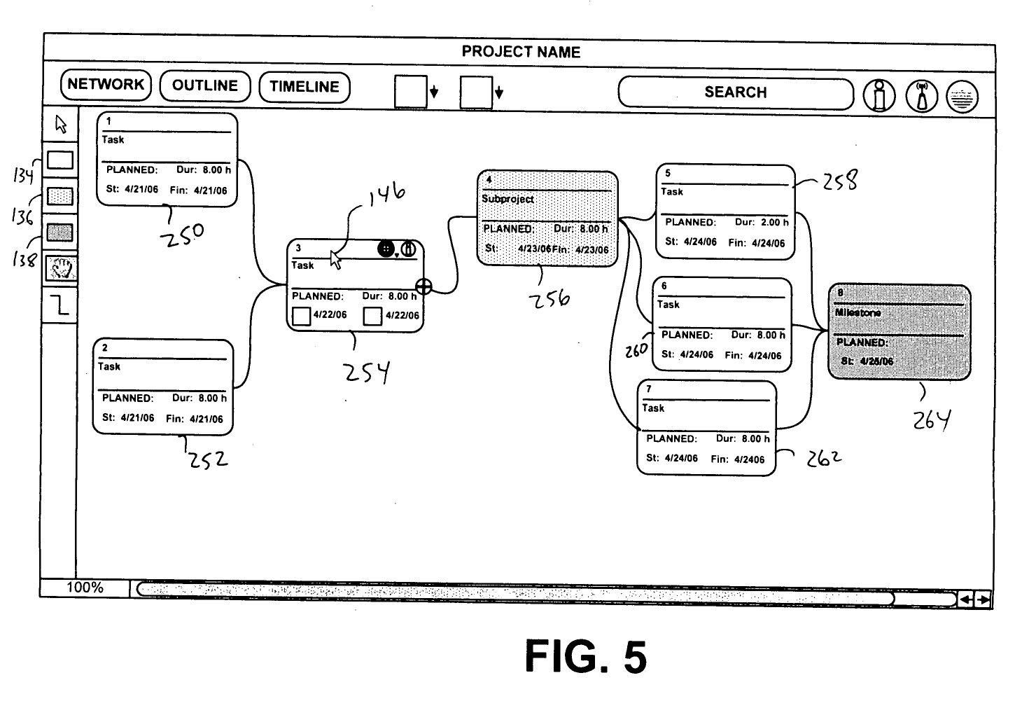

A project, built using graphical elements in the Network view of the instant invention, in the manner described above, is shown in FIG. 5. The graphical elements 250-264 of that project can be edited by mousing-over the desired element, and selecting the field to be edited, as shown in connection with task element 254. Further, subprojects can be expanded to show their underlying tasks by mousing-over a subproject element (such as, element 256 of FIG. 5) to display and activate the subproject expansion soft button (234 of FIG. 2D). Once expanded tasks, milestones and further subprojects can be added to the expanded subproject. The subproject, once expanded, can be collapsed using a keyboard or mouse entry, such as, by hitting a “back” soft button on the header bar (not shown).

Referring now to FIG. 6, there is shown the Network view screen of FIG. 5, wherein the soft button 120 has been actuated to bring up a task manager. As will be described more fully herebelow, the task manager 270 can be displayed in connection with each possible main view of the instant invention (i.e., Network, Outline, Timeline), merely by selecting the task manager button 120 along the tool bar 110, or, in the Network view, by actuating one of the information resource manager buttons 214 displayed when mousing-over any of the graphical elements. The task manager can be hidden by hitting the task manager button 120, a second time.

In one particularly preferred embodiment of the instant invention, in order to provide consistency and efficiency, the task manager 270 always appears in the same location in each view (i.e., Network, Outline, Timeline) of the present system. In a most preferred embodiment, the task manager 270, while activated, always appears horizontally across the bottom portion of the screen window, as shown in FIGS. 6-8.

The Outline View:

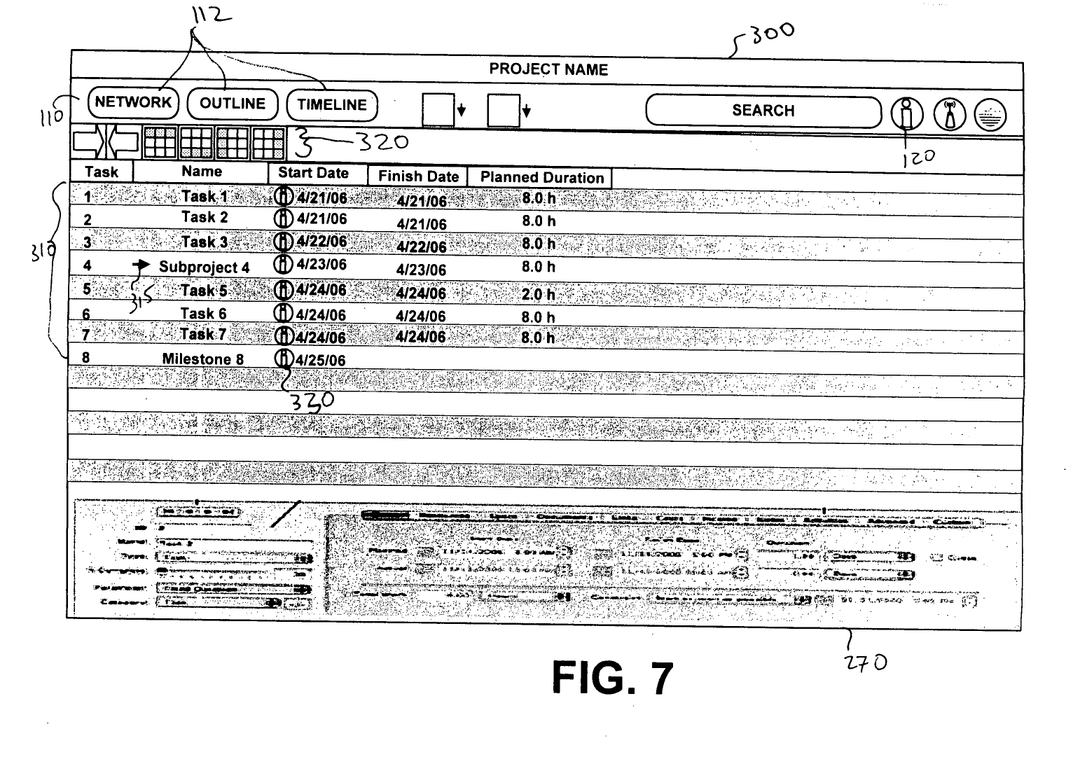

Referring now to FIG. 7, there is shown an example of an Outline view of a project in accordance with one embodiment of the instant invention.

The Outline view shown in FIG. 7, is used to display a project as a list 310, or outline, of tasks, subprojects and milestones. Tasks on the list can be selected, using a mouse or other pointer device of the workstation, in order to be expanded or collapsed. The outline view can be useful when importing task lists or projects from other applications. As described in connection with the Network view, the project shown in FIG. 7 can be displayed in other view styles by selecting a desired view using the view selection buttons 112 in the header bar 110 of each screen. Additionally, a user can interact with the tasks and/or subproject entries in the list 310 for the project shown on the Outline view, using the mouse and toolbox buttons 320. Functions that can be performed in the Outline view, using the toolbox buttons 310, include, indenting a subproject, removing an indent, adding or deleting columns and rows, and adding or deleting a subproject, among other functions. Additional toolbox buttons and menus may be added, if desired.

Additionally, as described in connection with the Network view, above, the task manager 270 can be selectively displayed by actuating the task manager button 120 on the tool bar 110 or, in the Outline view, actuating one of the task manager buttons 330, associated with each entry in the outline list 310. As in the Network and Timeline views, in the Outline view, while activated, the task manager 270 is displayed in a fixed, consistent location on the screen. Most preferably, the task manager 270, while activated, is located in a fixed location that is the same in all views of the system, horizontally across the bottom of the screen, as shown in FIGS. 6-8

The Timeline (GANTT) View:

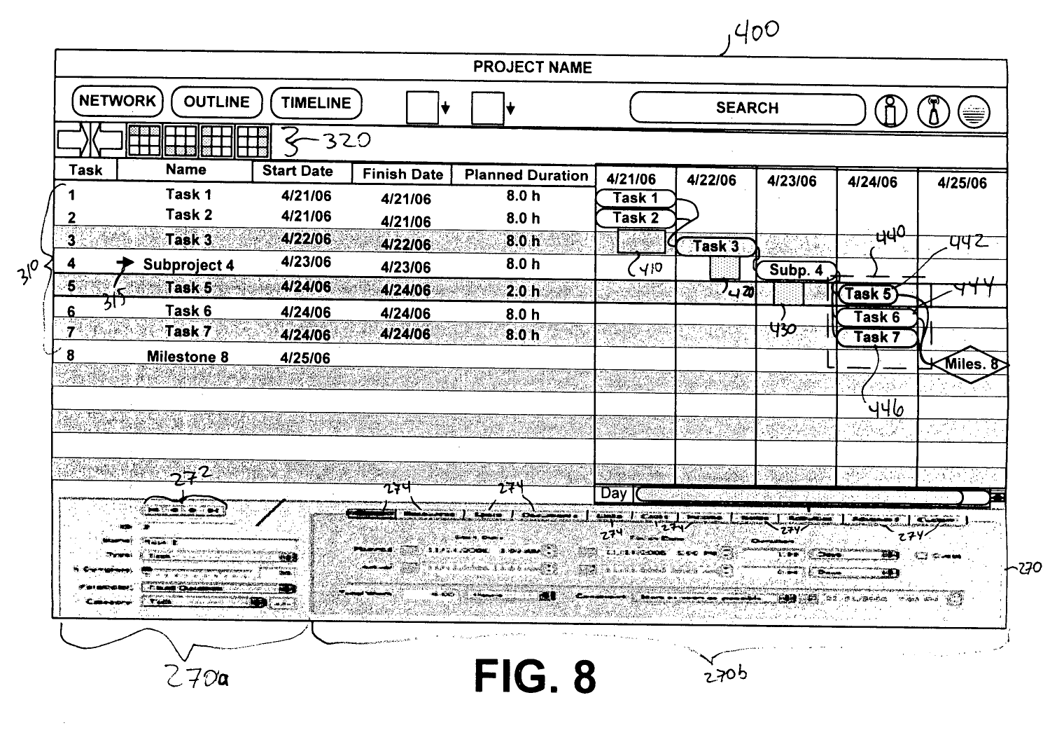

Referring now to FIG. 8, there is shown one example of a Timeline or Gantt view display 400, in accordance with one preferred embodiment of the instant invention. The timeline view of the present embodiment displays project tasks over calendar time. The Timeline view combines elements of the other two views (i.e., the Network and Outline views). Like the Network view, the Timeline view shows task links. Like the Outline view, the Timeline view displays the project as a list of tasks, with the ability to view all task levels.

In one preferred embodiment, to further associate the tasks in the Timeline view to the tasks in the other views, task colors are the same as in the network view. Milestones can be represented as other shapes, such as diamond shapes, having no duration. The task list of the Timeline view can be edited using the same tool box 320 used in the outline view.

Further, as in the network view, the linking hot spots of the graphical boxes of the tasks appear when the cursor is placed over a task. Once progress information or percent complete information has been entered in connection with a task, a second bar appears below the task bar showing progress. Progress bar can be associated with each element of the graphical view of the timeline. Additionally, such progress bars can be color-coded, if desired, as shown by progress bars 410, 420 and 430 in FIG. 8. For example, in one particular embodiment of the present invention, the progress bars of finished tasks are grey, progress bars in green indicate tasks proceeding on time, progress bars in red indicate tasks that are behind schedule and progress bars in yellow indicate tasks that are slipping. Additionally, a progress bar can be added to the view, showing overall progress, if desired.

Additionally, using the Timeline view, tasks can be grouped or “framed” to show subprojects. For example, in one particular embodiment of the invention, in the graphical portion of the Timeline/GANTT view of FIG. 8, a subproject can be represented by a “frame” or on-screen box 440, drawn around tasks 442, 444 and 446. Such framing indicates that the enclosed tasks are encompassed within a subproject. In the GANTT view of FIG. 8, subprojects can be expanded and collapsed by selecting the subproject and/or framed items in the list 310, for example, by selecting the arrow 315, or by selecting a task or subproject.

As with the previous views, in the Timeline view, while activated, the task manager 270 is displayed at a fixed consistent location, most preferably, horizontally across the bottom of the screen.

The Task Manager:

As discussed above, the project management system can include a task manager, selectively displayed on each view screen of the system, in order to provide information to the user. For example, FIGS. 6-8 show such a task manager, called in the instant case a “Task Inspector Drawer”, that is appended to each main creation screen view, respectively, of the present system. If desired such a task manager can be available from window or view of the project management system that contains tasks. Additionally, the task manager banner can be shown on the screen when desired, or closed, by clicking a “close” icon, to stay out of view, when not needed.

Referring more particularly to FIG. 8, it can be seen that the task manager of the present embodiment is divided into two sections 270a and 270b. The portion 270a contains general information related to a task. Arrow buttons 272 can be used to navigate through the tasks. The section 270b contains more specific information about a task, and includes a plurality of tabs 274, which can be accessed to access more specific information on each task.

Exemplary categories accessible by tabs 274 on the task manager include those referenced by the headings: dates, resources, specs, documents, links, costs, income, notes, activities, advanced and custom.

Accessing the dates tab on portion 270b of the task manager permits the entry of dates, constraints, parameters and other basic information. Additionally, changes can be made to the task type and category for reporting purposes. In one particular embodiment of the instant invention, actual dates and percent complete will not apply until the project is started and a baseline is saved.

The resources tab of the task manager allows the addition, deletion or viewing of resources assigned to a task, as well as view workload distribution. Resources can be added from the resources tab to a task by dragging them from the Resource Panel or the Address Book into the resources pane, or onto a task in the Network, Outline, or Timeline view. Additionally, in the present embodiment of the invention, For more accurate scheduling, a resource's efficiency can be set as a percentage, in the Resource View. A resource's availability for tasks can be defined at the task level. This helps control the distribution of a resource's available time among concurrent tasks. These settings, along with the number of resources assigned to a task are used to calculate the task's duration or workload distribution.

The specs tab of the task manager can be used to access and record the specifications, or performance standards expected for the task to be considered properly executed. These specifications are made available to the assigned resources to ensure they are aware of the defined performance standard.

The documents tab of the task manager can be used to access and store documents pertaining to the task by dragging them into the Documents pane.

The links tab of the task manager can be used to view and edit task relationships, dependencies, lead and lag times.

The cost of assigned resources is can be shown under the cost tab of the task manager.

Expected income such as disbursements, or payments for percentage of job completion, etc., can be tracked under the income tab in the task manager.

The notes tab contains a free-form text field for entering general notes pertaining to a task.

Under the activities tab of the task manager, meetings can be scheduled or viewed, emails and/or calls related to a task. Additionally, if desired, calls can be timed for billing purposes.

The advanced tab of the task manager can be used to provide PERT time estimates, using statistical analysis to generate time estimates.

Custom items pertaining to a task can be stored, viewed or edited under the custom tab of the task manager.

Updating and/or Tracking a Project:

Further, the project management system of the instant invention can include an integration mechanism so that data entered into other applications can be ported into the project management system without duplicative manual entry of the data. For example, in one particular embodiment, the project management system of the instant invention can be integrated with databases for such other applications as Mail, iCal and Address book, thus eliminating duplicate data, as well as duplicative data entry.

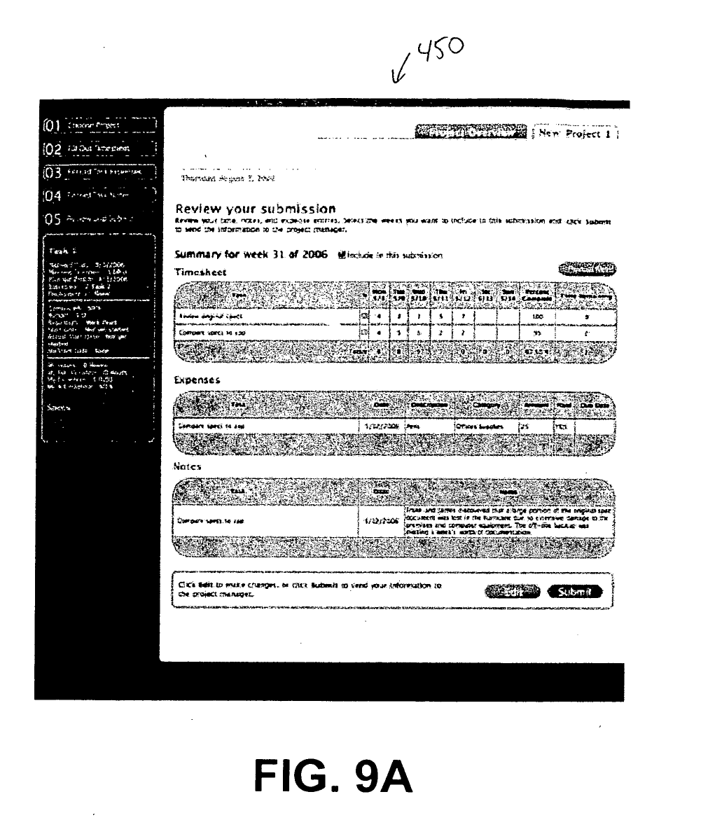

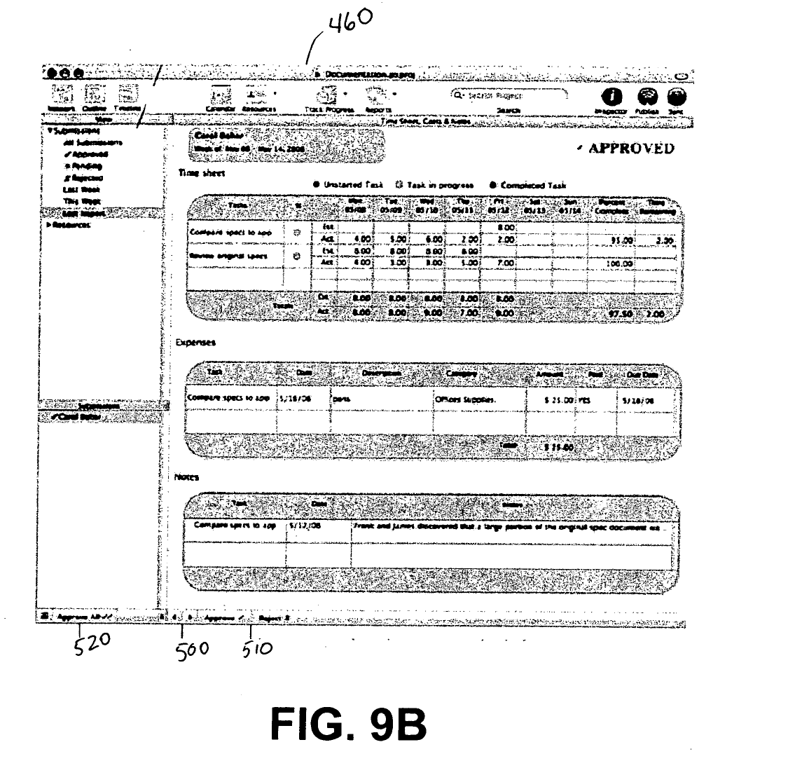

Additionally, the project management software of the instant invention can include tracking of projects. For example, referring now to FIG. 9A, there is shown an exemplary data entry screen 450 for an exemplary task. As shown in FIG. 9A, the project management system permits staff to update projects, submit time sheets, expenses, notes and documents to the system and/or project manager, using their own workstations. Once submitted, the information is transmitted to a project manager who may review the submission on a screen 460, such as is shown in FIG. 9B. From the screen 460 of FIG. 9B, a project manager, when reviewing the submission of an individual team member, has the ability to approve or reject an individual submission, using the buttons 500, 510.

Optionally, the project management system may be set to automatically approve all submissions, as with button 520 of FIG. 9B, or only submissions from certain users, without requiring separate approval from the project manager.

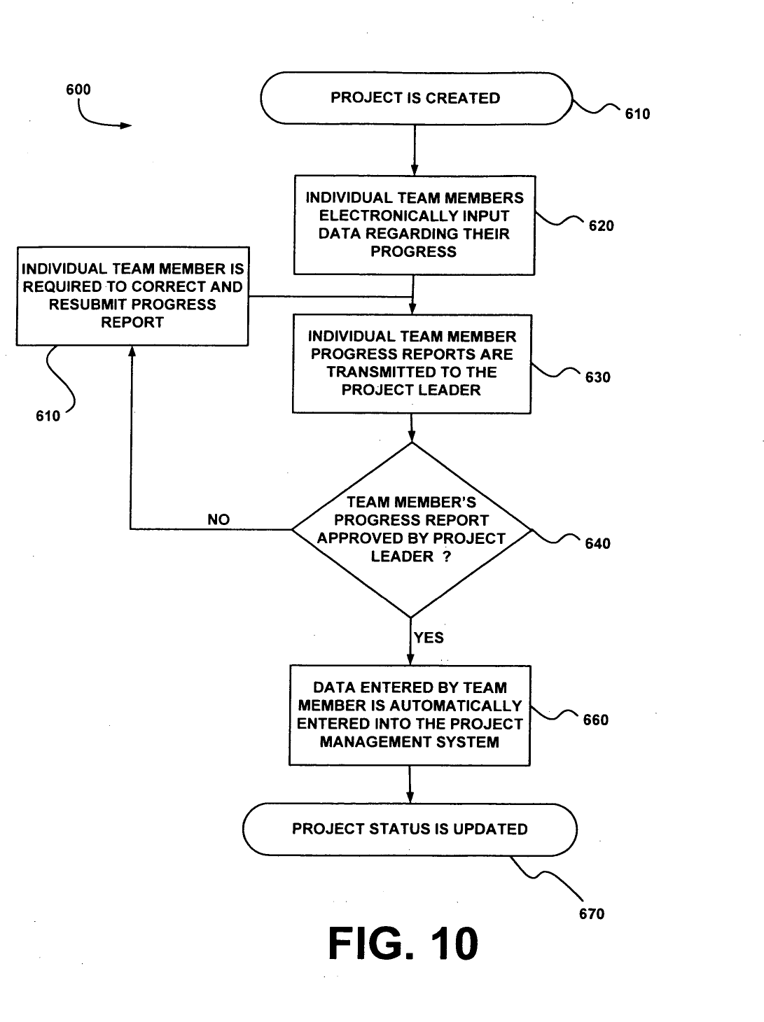

More particularly, referring now to FIG. 10, there is shown a flow diagram of a method 600 for managing a project. First, a project is created in any of the ways previously described herein. Step 610. For example, a project can be created using a Network view to create a graphical diagram of the tasks, subprojects and milestones. Such a project can be published to the team members using the publish button 122 on the tool bar of FIG. 3. As stated above, the project need not be hosted on a dedicated server, but can be created and maintained on a single workstation, or a plurality of workstations having shared access.

Once tasks are worked on and/or completed, individual team members electronically input data regarding their progress into forms, such as that shown in FIG. 9A. Step 620. The software for the form of FIG. 9A can be resident on each team member's workstation, or may be hosted on a single workstation or webserver accessible to the team members. Once submitted by the team member, the individual team member progress reports are electronically transmitted to the project leader. Step 630. In one particular embodiment of the instant application, a “widget” or activeX control on the desktop of the project manager's workstation, can be used to alert the project manager when a new submission has been received.

As described in connection with FIG. 9B, the program manager can individually review a team member's submission and approve or reject the submission. Step 640. Optionally, the system can be set to automatically approve all submissions, or all submissions of certain users, without interdiction by the project manager.

If a submission is rejected by the project manager, the team member is notified and is required to correct and resubmit the progress report. Step 650

If the project manager approves the individual's progress report, the data entered by the team member is automatically entered into the project management system. Step 660. As such, data does not have to be re-entered by the project manager to be used for project tracking. The data, entered once by the team member and approved by the project manager, is, itself, used to for project tracking. Once the data is entered, the project management system of the present invention automatically updates the project to reflect all approved submissions. Step 670.

As stated above, in the tracking portion of the project management system, team members can view projects, lists of assigned tasks, milestones, etc., on their own workstations, the information viewed by the users being stored on one or more users' workstation(s), which workstation(s) can act as a webserver. More particularly, in one embodiment of the instant invention, the project is hosted on an APPLE COMPUTER, INC., MACINTOSH™ computer using OS X's built-in APACHE Web Server. Once installed, a user can publish projects and make task information available to the team members. Once published, team members can access the project from any browser on the network, using the project's URL. Published projects will be available only when the host computer is turned on and connected to a network. Team members will be able to connect and view information for the tasks they are assigned. Additionally, team members will be able to use the browser interface to enter and submit time sheets, expenses and notes pertaining to their assigned tasks, which data can be ported into the project, without any need to reenter the data.

Note that the described embodiments are exemplary and that the above invention is not meant to be limited only to its preferred embodiments. For example, more or fewer than the three described main views can be provided and still be in keeping with the instant invention. Additionally, features of a present project management system and software that are known in the art of project management systems are not described separately herein, as it is understood that in the art that certain features are part of such a system (i.e., such as setting preferences, time units, costs, currency, etc.). It can be seen that other modifications can be made to the preferred embodiments and still be within the spirit of the present invention.

We claim:

1. A project management system, comprising:
a computer, including:
a processor,
a display device, and
a pointer device, to permit interaction with objects displayed on the display device using an on-screen pointer, the displayed location of said on-screen pointer being controlled by said pointer device;
said computer executing project management software providing a graphical interface, displayed on said display device, for managing a project represented by graphical elements located in a project window; and
said graphical elements being interactive such that additional information for a particular one of said graphical elements is displayed when the on-screen pointer is located over the particular one of said graphical elements.

2. The project management system of claim 1, wherein said additional information includes at least one of a soft button, a menu and a connection point.

3. The project management system of claim 1, wherein said pointer device is used to arrange said graphical elements in said project window by dragging and dropping the graphical elements at desired location in the project window.

4. The project management system of claim 3, wherein a graphical element can be linked to another graphical element in the project window by locating the on-screen pointer over a selected one of the graphical elements to display a connection point, selecting the connection point with the pointer device, dragging the on-screen pointer to a desired location and using the pointer device to drop the another graphical element at the desired location.

5. The project management system of claim 1, wherein said additional information includes at least one interactive calendar picker for selecting at least one of start date and finish date.

6. The project management system of claim 1, wherein said project management software can display the project in at least a second view by selectively converting the view of the project represented by graphical elements into at least one of an Outline view and a GANTT view of the project.

7. The project management system of claim 6, wherein said project management software further produces a selectively actuatable graphical interactive task manager banner, said task manager banner always being located at the same, fixed location on the display in connection with each possible project view, when actuated.

8. The project management system of claim 6, wherein said at least a second view is a GANTT view of the project, including a further graphical representation of the project as a plurality of GANTT view graphical elements, said pointer device being used to frame at least two of said GANTT view graphical elements in an on-screen box to designate said at least two of said GANTT view graphical elements as elements in a subproject.

9. A project management system, comprising:
a computer, including:
a processor,
a display device, and
a pointer device, to permit interaction with objects displayed on the display device using an on-screen pointer, the displayed location of said on-screen pointer being controlled by said pointer device;
said computer executing project management software providing a graphical interface, displayed on said display device, for managing a project represented by graphical elements located in a project window; and
said graphical elements being arranged in said project window by dragging a first graphical element onto said project window from a first location on said graphical interface and dropping said first graphical element onto said project window.

10. The project management system of claim 9, wherein said graphical elements include at least one of: a first type of graphical element representing a task, a second type of graphical element representing a subproject and a third type of graphical element representing a milestone.

11. The project management system of claim 9, wherein a second graphical element is linked to said first graphical element by locating the on-screen pointer over the first graphical element to display a connection point, selecting said connection point with said pointer device, dragging the on-screen pointer to a desired location and using the pointer device to drop a second graphical element at the desired location.

12. The project management system of claim 11, wherein said second graphical element is of the same type as the first graphical element.

13. The project management system of claim 11, wherein said second graphical element is of a different type than said first graphical element, said second type being selected from a second location on said graphical interface.

14. The project management system of claim 11, wherein said pointer device is used to edit at least one of said first graphical element and said second graphical element by locating said on-screen pointer over at least one of said first graphical element and said second graphical element to display and interact with additional information on the selected one of said first graphical element and said second graphical element.

15. A method for managing project information, comprising the steps of:
providing a computer, including a processor, a display device, and a pointer device for interacting with objects displayed on the display device using an on-screen pointer, the displayed location of the on-screen pointer being controlled by said pointer device;
providing a graphical interface, displayed on the display device, for creating and editing a project represented by at least one graphical element located in a project window; and
editing the at least one graphical element by locating the on-screen pointer over the at least one graphical element to display and interact with additional information on the at least one graphical element.

16. The method of claim 15, wherein said additional information includes at least one of a soft button, an interactive menu and an interactive connection point.

17. The method of claim 15, further including the step of dragging a second graphical element from a toolbox located on the graphical interface to a desired location on the project window using the pointer device, and dropping the second graphical element onto the desired location.

18. The method of claim 15, further including the step of dragging a second graphical element to a desired location on the project window by locating the on-screen pointer over the at least one graphical element to display a connection point, selecting the connection point with the pointer device, dragging the on-screen pointer to a desired location and using the pointer device to drop the second graphical element at the desired location.

19. A project management system, comprising:
a first workstation;
a second workstation, in communication with said first workstation, via a network;
project management software, hosted on said first workstation and accessible by said second workstation over said network, said project management software being used to manage at least one project; and
information entered on said second workstation being provided to said first workstation, and upon approval, said project management software using said information entered on said second workstation to update said information being used to update said at least one project without reentry.

20. The project management system of claim 19, wherein said second workstation accesses said first workstation using a browser.

21. The project management system of claim 19, wherein said approval must be manually entered into the program management system.

22. A project management system, comprising:
a computer, including:
a processor, and
a display device,
said computer executing project management software for managing a project, said project being displayed in a plurality of views; and
a selectively actuatable graphical interactive task manager banner, said task manager banner always being located at the same, fixed location on the display in connection with each of the plurality of views, when actuated.

23. The project management system of claim 22, wherein said graphical interactive task manager banner is always fixed horizontally, adjacent to the bottom edge of the display device, when actuated.

24. The project management system of claim 23, wherein said plurality of views includes at least two of the following views: a PERT view, an Outline view and a Gantt view.

25. A project management system, comprising:
a computer, including:
a processor, and
a display device,
said computer executing project management software for managing a project;
said project being displayed in at least a GANTT view representing said project in, both, list form and graphically as a plurality of GANTT view graphical elements; and
said project management software being able to selectively switch the display of subprojects in the graphical portion of the GANTT between the display of a single GANTT view graphical element representing the entire subproject and a plurality of GANTT view graphical elements framed by an on-screen box, said framed plurality of GANTT view graphical elements representing the individual elements of the subproject.

26. The project management system of claim 25, wherein the display is switched between said single GANTT view graphical element and said framed plurality of GANTT view graphical elements, by selecting the subproject in the list form portion of the GANTT view.
